(19) United States
(12) Patent Application Publication
(10) Pub. No.: US 2026/0278325 A1
(43) Pub. Date: Sep. 17, 2026

(54) ACCESS FILTER VIA SELECT COMMANDS

(71) Applicant: QUALCOMM Incorporated, San Diego, CA (US)

(72) Inventors: Qi FU, San Diego, CA (US); Bhupesh Manoharlal UMATT, San Diego, CA (US); Kiran PATIL, San Diego, CA (US); Scott HOOVER, Del Mar, CA (US); Sheng-Yuan TU, San Diego, CA (US); Chetan Jagdeesh BHARADWAJ, Erie, CO (US); Ajay Vignesh JAYAPRAKASH, San Diego, CA (US); Sayak SAHA, San Diego, CA (US)

(21) Appl. No.: 19/080,345

(22) Filed: Mar. 14, 2025

(51) Int. Cl. G06K 17/00; G06K 7/10

(52) U.S. Cl. CPC G06K 17/0029; G06K 7/10297

(57) ABSTRACT

In some aspects, a radio frequency identification (RFID) reader may select one or more filters to reduce a tag population to a tag sub-population. The RFID reader may transmit, to one or more tags in the tag population and as part of a set operation, one or more select commands associated with the one or more filters. The one or more filters may include one or more of a selection filter, a first access filter, or a second access filter. The set operation may command the one or more tags in the tag population to set or update a selected flag value or an inventoried flag value in accordance with one or more of the selection filter, the first access filter, or the second access filter. Numerous other aspects are described.

### FIELD OF THE DISCLOSURE

Aspects of the present disclosure generally relate to radio frequency identification (RFID) communication and, for example, to implementing RFID access filters through select commands.

### BACKGROUND

Radio frequency identification (RFID) communication is a wireless communication system that facilitates communication between an RFID tag and an RFID reader. The RFID tag is a device that includes circuitry for receiving and responding to radio frequency signals. The RFID reader is a device for transmitting radio frequency signals to, and receiving radio frequency signals from, the RFID tag. The RFID reader may broadcast a continuous wave, which may power the RFID tag. The RFID reader may transmit one or more commands, queries, or other signals to the RFID tag during an RFID communication session.

### SUMMARY

Some aspects described herein relate to a radio frequency identification (RFID) reader. The RFID reader may include a processing system. The processing system may include one or more processors and one or more code-storing memories coupled with the one or more processors. The processing system may be configured to cause the RFID reader to select one or more filters to reduce a tag population to a tag sub-population. The processing system may be configured to cause the RFID reader to transmit, to one or more tags in the tag population and as part of a set operation, one or more select commands associated with the one or more filters. The one or more filters may include one or more of a selection filter, a first access filter, or a second access filter. The set operation may command the one or more tags in the tag population to set or update a selected flag value or an inventoried flag value in accordance with one or more of the selection filter, the first access filter, or the second access filter.

Some aspects described herein relate to a method of wireless communication performed by an RFID reader. The method may include selecting one or more filters to reduce a tag population to a tag sub-population. The method may include transmitting, to one or more tags in the tag population and as part of a set operation, one or more select commands associated with the one or more filters. The one or more filters may include one or more of a selection filter, a first access filter, or a second access filter. The set operation may command the one or more tags in the tag population to set or update a selected flag value or an inventoried flag value in accordance with one or more of the selection filter, the first access filter, or the second access filter.

Some aspects described herein relate to a non-transitory computer-readable medium that stores a set of instructions for wireless communication by an RFID reader. The set of instructions, when executed by one or more processors of the RFID reader, may cause the RFID reader to select one or more filters to reduce a tag population to a tag sub-population. The set of instructions, when executed by one or more processors of the RFID reader, may cause the RFID reader to transmit, to one or more tags in the tag population and as part of a set operation, one or more select commands associated with the one or more filters. The one or more filters may include one or more of a selection filter, a first access filter, or a second access filter. The set operation may command the one or more tags in the tag population to set or update a selected flag value or an inventoried flag value in accordance with one or more of the selection filter, the first access filter, or the second access filter.

Some aspects described herein relate to an apparatus for wireless communication. The apparatus may include means for selecting one or more filters to reduce a tag population to a tag sub-population. The apparatus may include means for transmitting, to one or more tags in the tag population and as part of a set operation, one or more select commands associated with the one or more filters. The one or more filters may include one or more of a selection filter, a first access filter, or a second access filter. The set operation may command the one or more tags in the tag population to set or update a selected flag value or an inventoried flag value in accordance with one or more of the selection filter, the first access filter, or the second access filter.

Aspects generally include a method, apparatus, system, computer program product, non-transitory computer-readable medium, user device, user equipment, wireless communication device, or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram of an example environment in which systems or methods described herein may be implemented.

FIG. 2 is a diagram illustrating example components of a device, in accordance with the present disclosure.

FIG. 3 is a diagram illustrating an example associated with filtering a radio frequency identification (RFID) tag population using select commands.

FIG. 4 is a diagram illustrating an example with RFID communication between RFID tags in a tag population and an RFID reader.

FIG. 5 is a flowchart of an example process associated with filtering an RFID tag population using select commands.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Radio frequency identification (RFID) is a wireless communication technique that involves the transmission and reception of radio frequency signals for the purpose of identifying objects. In an RFID communication system, a reader may communicate with one or more tags in a tag population. The reader may transmit commands, queries, and other signals to the tags in the tag population, and one or more of the tags in the tag population may respond, via a backscatter communication, with data stored in the tag.

In some situations, the reader may not need a response from each tag in the tag population. Accordingly, for a particular RFID procedure (such as an inventory procedure), the reader may broadcast one or more select commands to the tags in the tag population, and the tags may set a flag indicating whether or not the tag is expected to participate in the RFID procedure. The select commands may include information or instructions for the tag to determine whether or not the tag should participate in the RFID procedure.

Limitations with select commands may prevent the reader from fully excluding the correct tags from the tag population for the RFID procedure. For example, select commands may be limited to requesting that each of the tags in the tag population compare consecutive bits stored in the tag's memory to determine whether the tag should participate in the RFID procedure. Comparing consecutive bits may not be sufficient for the reader to fully exclude one or more tags from the RFID procedure. Accordingly, to further limit which tags respond to communications from the reader during the RFID procedure, the reader may transmit an access filter with additional commands (such as read commands) during the RFID procedure. Only tags that meet the criteria of the select command and satisfy the access filter may reply to access operation commands from the reader. For example, the reader may transmit a select command that excludes one or more tags from an inventory procedure. After the tags are inventoried, only tags that meet one or more access filter conditions may reply to access commands. Because select commands may not be able to fully exclude the correct tags from the tag population for the RFID procedure, at least some non-participating tags may receive and process commands with access filters to be excluded from additional reader access operations.

Some implementations described herein enable the reader to minimize use of access filters by transmitting one or more select commands as part of a set operation. The select commands in the set operation may cause the tags in the tag population to update or set a selected flag value or an inventoried flag value. As a result of the set operation, only the tags in the tag population that satisfy the criteria of all of the select commands will participate in the RFID operation. Because the reader can more precisely limit the tags that participate in the RFID operation, the reader may transmit fewer commands with access filters, which may reduce the number of participating tags (which may improve the inventory procedure), reduce the number of reader commands (e.g., access operations after each tag is inventoried), or a combination thereof, among other examples.

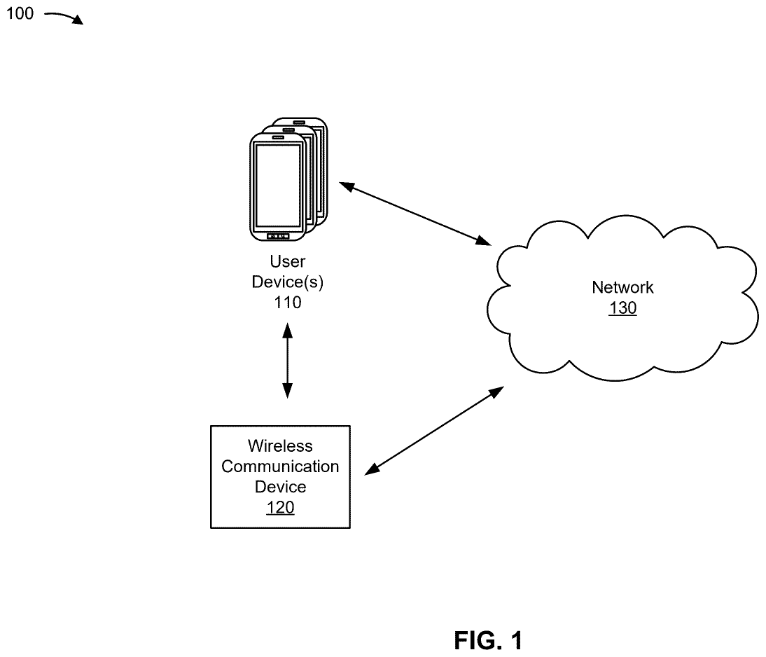

FIG. 1 is a diagram of an example environment 100 in which systems or methods described herein may be implemented. As shown in FIG. 1, environment 100 may include one or more user devices 110 (e.g., one or more RFID tags), a wireless communication device 120 (e.g., a reader or a user equipment (UE)), and a network 130. Devices of environment 100 may interconnect via wired connections, wireless connections, or a combination of wired and wireless connections.

The user devices 110 may include one or more devices capable of receiving, generating, storing, processing, or providing information associated with unit operations for RFID communication with the wireless communication device 120, as described elsewhere herein. Each of the user devices 110 may include a communication device or a computing device. For example, each of the user devices 110 may include a wireless communication device, an RFID tag, a mobile phone, a UE, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The wireless communication device 120 may include one or more devices capable of receiving, generating, storing, processing, or providing information associated with unit operations for RFID communications with the one or more user devices 110. For example, the wireless communication device 120 may include an RFID reader (e.g., a “reader”), a base station, an access point, or the like. Additionally, or alternatively, wireless communication device 120 may include a communication or computing device, such as a mobile phone, a UE, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The network 130 may include one or more wired or wireless networks. For example, the network 130 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, or a combination of these or other types of networks. The network 130 enables communication among the devices of environment 100.

The number and arrangement of devices and networks shown in FIG. 1 are provided as an example. In practice, there may be additional devices or networks, fewer devices or networks, different devices or networks, or differently arranged devices or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

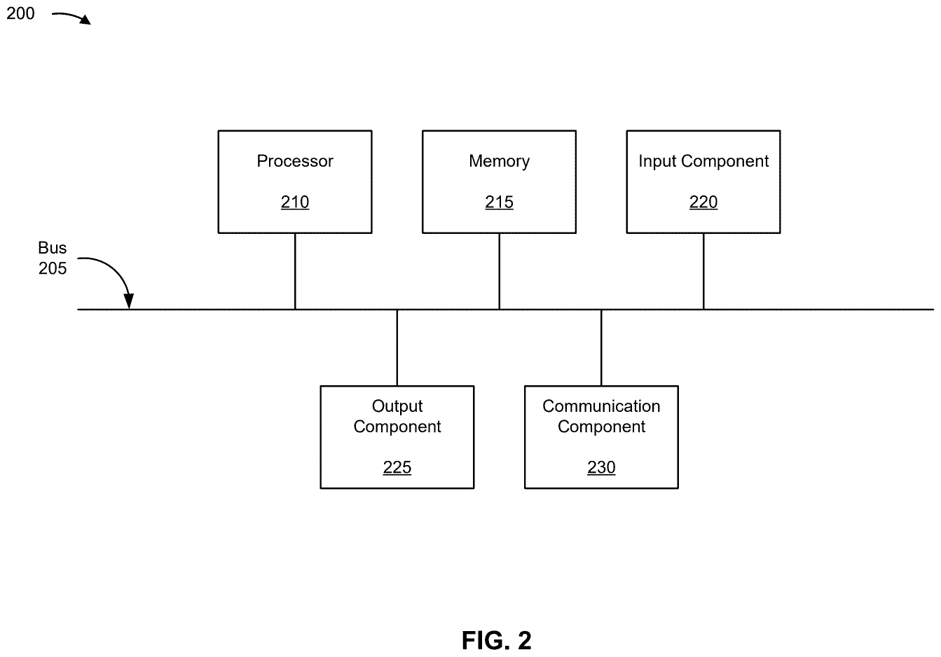

FIG. 2 is a diagram illustrating example components of a device 200, in accordance with the present disclosure. The device 200 may correspond to an RFID tag or a reader. In some aspects, the RFID tag or the reader may include one or more devices 200 or one or more components of the device 200. As shown in FIG. 2, the device 200 may include a bus 205, a processor 210, a memory 215, an input component 220, an output component 225, and a communication component 230.

The bus 205 may include one or more components that enable wired or wireless communication among the components of the device 200. The bus 205 may couple together two or more components of FIG. 2, such as via operative coupling, communicative coupling, electronic coupling, or electric coupling. For example, the bus 205 may include an electrical connection (e.g., a wire, a trace, or a lead) or a wireless bus. The processor 210 may include a central processing unit, a graphics processing unit, a microprocessor, a controller, a microcontroller, a digital signal processor, a field-programmable gate array, an application-specific integrated circuit, or another type of processing component. The processor 210 may be implemented in hardware, firmware, or a combination of hardware and software. In some aspects, the processor 210 may include one or more processors capable of being programmed to perform one or more operations or processes described elsewhere herein.

The memory 215 may include volatile or nonvolatile memory. For example, the memory 215 may include random access memory (RAM), read only memory (ROM), a hard disk drive, or another type of memory (e.g., a flash memory, a magnetic memory, or an optical memory). The memory 215 may include internal memory (e.g., RAM, ROM, or a hard disk drive) or removable memory (e.g., removable via a universal serial bus connection). The memory 215 may be a non-transitory computer-readable medium. The memory 215 may store information, one or more instructions, or software (e.g., one or more software applications) related to the operation of the device 200. In some aspects, the memory 215 may include one or more memories that are coupled (e.g., communicatively coupled) to one or more processors (e.g., processor 210), such as via the bus 205. Communicative coupling between a processor 210 and a memory 215 may enable the processor 210 to read or process information stored in the memory 215 or to store information in the memory 215.

The input component 220 may enable the device 200 to receive input, such as user input or sensed input. For example, the input component 220 may include a touch screen, a keyboard, a keypad, a mouse, a button, a microphone, a switch, a sensor, a global positioning system sensor, a global navigation satellite system sensor, an accelerometer, a gyroscope, or an actuator. The output component 225 may enable the device 200 to provide output, such as via a display, a speaker, or a light-emitting diode. The communication component 230 may enable the device 200 to communicate with other devices via a wired connection or a wireless connection. For example, the communication component 230 may include a receiver, a transmitter, a transceiver, a modem, a network interface card, or an antenna.

The device 200 may perform one or more operations or processes described herein. For example, a non-transitory computer-readable medium (e.g., memory 215) may store a set of instructions (e.g., one or more instructions or code) for execution by the processor 210. The processor 210 may execute the set of instructions to perform one or more operations or processes described herein. In some aspects, execution of the set of instructions, by one or more processors 210, causes the one or more processors 210 or the device 200 to perform one or more operations or processes described herein. In some aspects, hardwired circuitry may be used instead of or in combination with the instructions to perform one or more operations or processes described herein. Additionally, or alternatively, the processor 210 may be configured to perform one or more operations or processes described herein. Thus, aspects described herein are not limited to any specific combination of hardware circuitry and software.

In some aspects, device 200 may include means for selecting one or more filters to reduce a tag population to a tag sub-population; or means for transmitting, to one or more tags in the tag population and as part of a set operation, one or more select commands associated with the one or more filters. The one or more filters may include one or more of a selection filter, a first access filter, or a second access filter. The set operation may command the one or more tags in the tag population to set or update a selected flag value or an inventoried flag value in accordance with one or more of the selection filter, the first access filter, or the second access filter. In some aspects, the means for device 200 to perform processes or operations described herein may include one or more components of device 200 described in connection with FIG. 2, such as bus 205, processor 210, memory 215, input component 220, output component 225, communication component 230, or a combination thereof, among other examples.

The number and arrangement of components shown in FIG. 2 are provided as an example. The device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

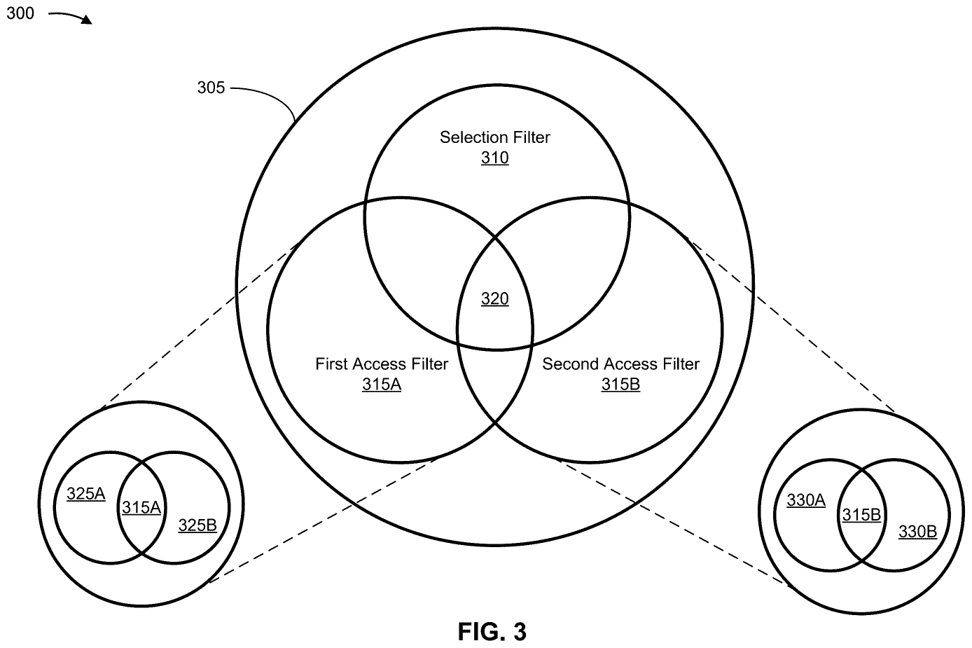

FIG. 3 is a diagram illustrating an example 300 associated with filtering an RFID tag population using select commands. As shown in FIG. 3, example 300 includes communication between a reader (e.g., wireless communication device 120) and one or more tags (e.g., user devices 110) in a tag population).

With reference to FIG. 3, a tag population 305 may include multiple tags in communication with the reader. The reader may select one or more filters to reduce the tag population 305. As shown in the example 300 of FIG. 3, the one or more filters may include a selection filter 310, a first access filter 315A, and a second access filter 315B. The filters applied by the tags may be associated with a set operation, and the set operation may include one or more select commands transmitted from the reader to the tags in the tag population 305.

The selection filter 310 may be associated with one or more select commands. In some aspects, the select command may command the tags in the tag population 305 to set a selected flag value or an inventoried flag value in accordance with one or more criteria included in the select command. Accordingly, the selection filter 310 may be used by the reader to reduce the tag population 305 in accordance with one or more rules for select commands as defined by an RFID protocol or standard. The first access filter 315A and the second access filter 315B may correspond to one or more filters to reduce the tag population 305 in accordance with one or more rules for access filters as defined by the RFID protocol or standard. In some aspects, the RFID protocol or standard may define rules for the tags in the tag population 305 to apply the access filters without setting a flag value such as a selected flag value or an inventoried flag value. Further, the RFID protocol or standard may include one or more rules for the reader to transmit the access filter in a read command rather than in a select command. In the example 300 of FIG. 3, however, the first access filter 315A and the second access filter 315B may be transmitted as select commands that command the tags in the tag population 305 to set or update one or more flag values such as the selected flag value or the inventoried flag value. The tags in the tag population 305 may apply the selection filter 310, the first access filter 315A, and the second access filter 315B received via one or more select commands as part of a set operation. As a result, the tag population 305 may be reduced to a tag sub-population 320 that includes fewer tags than the tag population 305. In some aspects, the tag sub-population 320 is the intersection of the sets of tags that satisfy criteria of the selection filter 310, the first access filter 315A, and the second access filter 315B.

In some aspects, the select commands transmitted by the reader may command the tags in the tag population 305 to set or update the selected flag value or the inventoried flag value by asserting the selected flag value or inventoried flag value (e.g., setting the flag value to “1” or to an active or TRUE condition), de-asserting the selected flag value or the inventoried flag value (e.g., setting the flag value to “0 ” or to an inactive or FALSE condition), or negating one or more of the selected flag value or the inventoried flag value (e.g., switching the flag value to an opposite flag value, such as switching the flag value from “0 ” or the FALSE condition to “1” or the TRUE condition). In some aspects, the select commands may command the tags in the tag population 305 to set or update the flag value as a result of the tag satisfying the criteria, failing to satisfy the criteria, or both. For example, in some aspects, a select command may command the tags in the tag population 305 that satisfy the criteria in the select command to assert the flag value and command the tags in the tag population 305 that do not satisfy the criteria in the select command to de-assert the flag value.

In some aspects, one or more of the first access filter 315A and the second access filter 315B may be implemented as two or more sub-filters. For example, the tags that set or update a flag value in accordance with the first access filter 315A may be the tags in the tag population 305 that satisfy the criteria of a first sub-filter 325A and a second sub-filter 325B. Similarly, the tags that set or update a flag value in accordance with the second access filter 315B may be the tags in the tag population 305 that satisfy the criteria of a first sub-filter 330A and a second sub-filter 330B. Accordingly, the tags that satisfy the criteria of the first access filter 315A may be defined in accordance with the intersection of the first sub-filter 325A and the second sub-filter 325B, and the tags that satisfy the criteria of the second access filter 315B may be defined in accordance with the intersection of the first sub-filter 330A and the second sub-filter 330B.

In some aspects, criteria associated with the first access filter 315A, the second access filter 315B, or a combination thereof, among other examples, may be defined in the negative rather than in the affirmative. For example, in some aspects, the first access filter 315A, the second access filter 315B, or both, may define criteria to exclude one or more tags from the tag sub-population 320, rather than define criteria to include one or more tags in the tag sub-population 320. In some aspects, the first sub-filter 325A, the first sub-filter 330A, the second sub-filter 325B, the second sub-filter 330B, or a combination thereof, may be defined in the affirmative, the negative, or a combination thereof.

As indicated above, FIG. 3 is provided as an example. Other examples may differ from what is described with respect to FIG. 3. For example, in some aspects, the tag sub-population 320 may be the result of additional select filters, no select filters, additional access filters, or no access filters. Additionally, the access filters may include more than two sub-filters or no sub-filters. In some aspects, different access filters may include different quantities of sub-filters, including zero sub-filters.

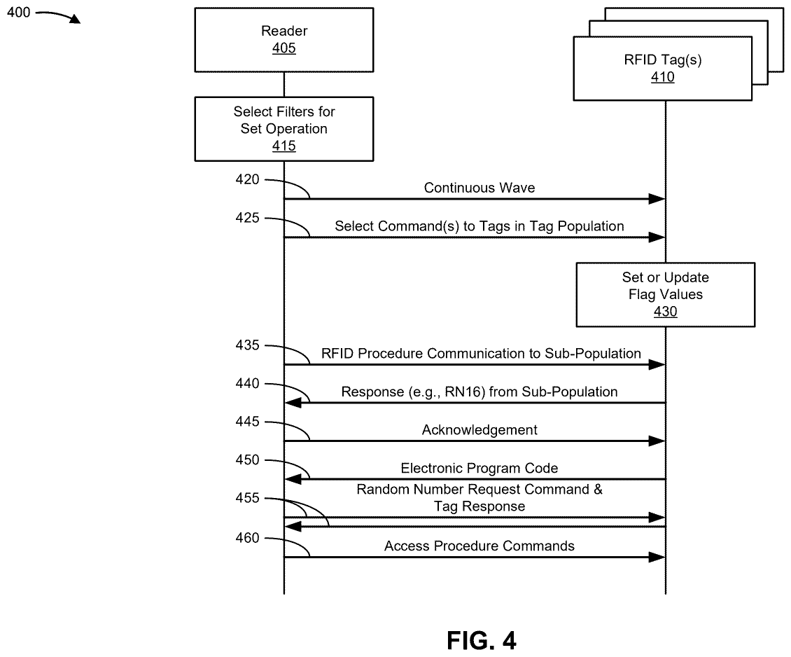

FIG. 4 is a diagram illustrating an example 400 with RFID communication between RFID tags in a tag population and an RFID reader. As shown in FIG. 4, a reader 405 (e.g., a wireless communication device 120) and one or more RFID tags 410 (e.g., one or more user devices 110) may communicate with one another.

As shown by reference number 415, the reader 405 may select one or more filters to transmit, to the RFID tags 410 in the tag population, for a set operation. In some aspects, the reader 505 may select the one or more filters to selectively reduce the RFID tags 410 in the tag population to a tag sub-population that includes fewer RFID tags 410 than the number of RFID tags 410 included in the tag population. In some aspects, the set operation may include one or more select commands that cause the RFID tags 410 in the tag population to set or update a flag value, such as a selected flag value or an inventoried flag value. Setting or updating the flag value may include asserting the flag value, de-asserting the flag value, or negating the flag value.

In some aspects, the reader 405 may select the one or more filters by translating one or more access filters to two or more sub-filters that can be transmitted to the RFID tags 410 in the tag population as select commands. In some aspects, each sub-filter may include criteria associated with consecutive values (e.g., consecutive 1s or 0s) in a bitmask. For example, an access filter may be defined in accordance with a target value of 0xDE00AD with a bitmask of 0xFF00FF defined in an access filter. The tag mask value of 0xDE00AD may have two sets of consecutive bitmap values. Accordingly, the reader 405 may deconstruct the access filter into a first sub-filter that applies a tag mask of 0xFF to a configured memory bank pointer to compare with a target value of 0xDE, and applies a tag mask of 0xFF to a same configured memory bank pointer location plus, for example, 16 bits to compare with the target value of 0xAD. The set of RFID tags 410 that satisfy the criteria of both the first sub-filter and of the second sub-filter may set or update the flag value. In some aspects, the reader 405 may determine an order of the select commands in accordance with the filters. For example, the reader 405 may determine or schedule the order of the select commands so that only the desired RFID tags 410 are included in the tag sub-population after all of the select commands are transmitted.

In some aspects, the RFID reader 405 may select one or more actions associated with each filter, each select command, or a combination thereof, among other examples. For example, an action may include asserting a flag value, de-asserting a flag value, negating a flag value, or keeping a flag value as-is. In some aspects, one action value (e.g., action 010) may command matching RFID tags 410 to not make any changes to the flag value and command non-matching RFID tags 410 to set an inventoried flag value to a value B. A subsequent select command may be transmitted with an action value (e.g., action 101) that commands matching RFID tags 410 to set or update the inventoried flag value to value B and for non-matching RFID tags 410 to not take any action. Another action (e.g., action 000) may command matching RFID tags 410 to set the inventoried flag value to value A and for non-matching RFID tags 410 to set the inventoried flag value to value B.

As shown by reference number 420, the reader 405 may transmit, and the one or more RFID tags 410 in the tag population may receive, a continuous wave. In some aspects, the continuous wave may power the RFID tags 410 in the tag population for a duration of an RFID procedure.

As shown by reference number 425, the reader 405 may transmit, and the RFID tags 410 may receive, one or more select commands. In some aspects, the one or more select commands may be part of the set operation. For example, the one or more select commands may command the RFID tags 410 in the tag population to set or update the flag values in accordance with the filters included in the set operation. In some aspects, each RFID tag 410 in the tag population may set or update the flag value in response to each select command received. In some aspects, select commands for selection filters (e.g., the selection filters 310 of FIG. 3) may be transmitted before select commands for access filters (e.g., access filters 315 of FIG. 3). In some aspects, one or more sub-filters (e.g., sub-filters 325 or 330) of a first access filter may be transmitted sequentially before one or more sub-filters of a second access filter. Alternatively or additionally, in some aspects, one or more sub-filters of the second access filter may be transmitted sequentially before one or more sub-filters of the first access filter.

As shown by reference number 430, the RFID tags 410 may set or update the flag value in accordance with the one or more set commands transmitted by the reader 405. For example, in some aspects, each RFID tag 410 may set or update the selected flag value or the inventoried flag value, among other examples, in accordance with whether the RFID tag 410 satisfies criteria of one or more filters, such as one or more select filters, one or more access filters, one or more sub-filters of the one or more access filters, or a combination thereof, among other examples. In some aspects, setting or updating the flag value may include asserting, de-asserting, or negating the flag value. As a result of setting or updating the flag values, the tag population may be reduced to the tag sub-population.

As shown by reference number 435, the reader 405 may transmit, and the RFID tags 410 in the tag sub-population may receive, an RFID procedure communication. The RFID procedure communication may include a query command (e.g., Query), a read command, a query repetition command (e.g., QueryRep), a query adjust command (e.g., QueryAdjust), or a combination thereof, among other examples.

As shown by reference number 440, the reader 405 may receive, and the RFID tags 410 in the tag sub-population may reply with, a response. In some aspects, the response is an RN16 message transmitted in response to the RFID procedure communication. In some aspects, the response is transmitted while the one or more RFID tags 410 in the tag sub-population are receiving the continuous wave. For example, the one or more RFID tags 410 in the tag sub-population may transmit the response using a backscatter link.

As shown by reference number 445, the reader 405 may transmit, and the RFID tags 410 in the tag sub-population may receive, an acknowledgement (ACK). The ACK may indicate that the reader 405 received the response (e.g., RN16) from the RFID tag 410 in the tag sub-population.

As shown by reference number 450, the RFID tag 410 may transmit, and the reader 405 may receive, an electronic product code. The RFID tag 410 that transmits the electronic product code may transmit the electronic product code in response to the ACK received from the reader 405.

In some aspects, even though the select commands may be used to reduce the tag population to the tag sub-population, there may be situations in which the reader 405 is unable to fully exclude a correct subset of the RFID tags 410 from the sub-population. Accordingly, in some aspects, the RFID reader 405 may transmit one or more access filters with, for example, a read command to the RFID tags 410 of the tag sub-population.

For example, as shown by reference number 455, the reader 405 may transmit, and the RFID tag 410 may receive, a random number request (e.g., Req_RN) command to bring the RFID tag 410 into an open or secure state in which the reader 405 may transmit additional commands such as read commands, write commands, or kill commands, among other examples. RFID tags 410 that do not receive or respond to the random number request command may ignore the additional commands transmitted by the reader 405.

As shown by reference number 460, the reader 405 may perform one or more access procedures. For example, the reader 405 may perform a read procedure for an access filter, read operations, write operations, kill operations, lock operations, or a combination thereof, among other examples. In some aspects, the RFID reader 405 may transmit one or more access filters with, for example, a read command to the RFID tags 410 of the tag sub-population, as discussed above. In some aspects, the access procedures may include one or more access procedures discussed above with respect to the example 300 of FIG. 3.

As indicated above, FIG. 4 is provided as an example. Other examples may differ from what is described with respect to FIG. 4.

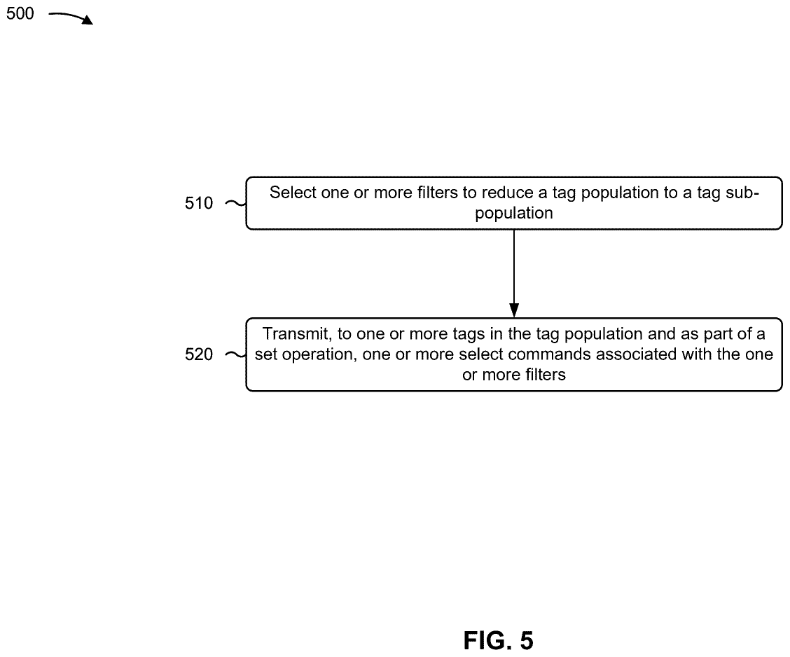

FIG. 5 is a flowchart of an example process 500 associated with filtering an RFID tag population using select commands. In some aspects, one or more process blocks of FIG. 5 are performed by an RFID reader (e.g., RFID reader 405 or wireless communication device 120). In some aspects, one or more process blocks of FIG. 5 are performed by another device or a group of devices separate from or including the RFID reader. Additionally, or alternatively, one or more process blocks of FIG. 5 may be performed by one or more components of device 200, such as processor 210, memory 215, input component 220, output component 225, or communication component 230.

As shown in FIG. 5, process 500 may include selecting one or more filters to reduce a tag population to a tag sub-population (block 510). For example, the RFID reader may select one or more filters to reduce a tag population to a tag sub-population, as described above.

As further shown in FIG. 5, process 500 may include transmitting, to one or more tags in the tag population and as part of a set operation, one or more select commands associated with the one or more filters, wherein the one or more filters include one or more of a selection filter, a first access filter, or a second access filter. The set operation may command the one or more tags in the tag population to set or update a selected flag value or an inventoried flag value in accordance with one or more of the selection filter, the first access filter, or the second access filter (block 520). For example, the RFID reader may transmit, to one or more tags in the tag population and as part of a set operation, one or more select commands associated with the one or more filters. In some aspects, the one or more filters include one or more of a selection filter, a first access filter, or a second access filter. In some aspects, the set operation commands the one or more tags in the tag population to set or update a selected flag value or an inventoried flag value in accordance with one or more of the selection filter, the first access filter, or the second access filter.

Process 500 may include additional aspects, such as any single aspect or any combination of aspects described below or in connection with one or more other processes described elsewhere herein.

In a first aspect, commanding the one or more tags in the tag population to set or update the selected flag value or the inventoried flag value includes commanding the one or more tags in the tag population to assert, de-assert, or negate one or more of the selected flag value or the inventoried flag value.

In a second aspect, alone or in combination with the first aspect, the first access filter includes one or more sub-filters including one or more of a first sub-filter or a second sub-filter.

In a third aspect, alone or in combination with one or more of the first and second aspects, each of the one or more sub-filters is associated with consecutive bitmask values.

In a fourth aspect, alone or in combination with one or more of the first through third aspects, the second access filter includes one or more sub-filters including one or more of a first sub-filter or a second sub-filter.

In a fifth aspect, alone or in combination with one or more of the first through fourth aspects, process 500 includes transmitting, to the one or more tags in the tag population, a read command in accordance with one or more of the first access filter or the second access filter.

In a sixth aspect, alone or in combination with one or more of the first through fifth aspects, transmitting the one or more select commands includes transmitting the one or more select commands in accordance with one or more parameters.

In a seventh aspect, alone or in combination with one or more of the first through sixth aspects, each of the one or more parameters is associated with an action field.

In an eighth aspect, alone or in combination with one or more of the first through seventh aspects, process 500 includes determining an order of the one or more filters.

In a ninth aspect, alone or in combination with one or more of the first through eighth aspects, determining the order of the one or more filters includes scheduling the selection filter to be transmitted before one or more of the first access filter or the second access filter.

In a tenth aspect, alone or in combination with one or more of the first through ninth aspects, determining the order of the one or more filters includes scheduling two or more sub-filters of the first access filter to be transmitted before the second access filter or one or more sub-filters of the second access filter.

In an eleventh aspect, alone or in combination with one or more of the first through tenth aspects, determining the order of the one or more filters includes scheduling two or more sub-filters of the first access filter or the second access filter to be transmitted sequentially.

Although FIG. 5 shows example blocks of process 500, in some aspects, process 500 includes additional blocks, fewer blocks, different blocks, or differently arranged blocks than those depicted in FIG. 5. Additionally, or alternatively, two or more of the blocks of process 500 may be performed in parallel.

The following provides an overview of some Aspects of the present disclosure:

Aspect 1: A method of wireless communication performed by a radio frequency identification reader, comprising: selecting one or more filters to reduce a tag population to a tag sub-population; and transmitting, to one or more tags in the tag population and as part of a set operation, one or more select commands associated with the one or more filters, wherein the one or more filters include one or more of a selection filter, a first access filter, or a second access filter, wherein the set operation commands the one or more tags in the tag population to set or update a selected flag value or an inventoried flag value in accordance with one or more of the selection filter, the first access filter, or the second access filter.

Aspect 2: The method of Aspect 1, wherein commanding the one or more tags in the tag population to set or update the selected flag value or the inventoried flag value includes commanding the one or more tags in the tag population to assert, de-assert, or negate one or more of the selected flag value or the inventoried flag value.

Aspect 3: The method of any of Aspects 1-2, wherein the first access filter includes one or more sub-filters including one or more of a first sub-filter or a second sub-filter.

Aspect 4: The method of Aspect 3, wherein each of the one or more sub-filters is associated with consecutive bitmask values.

Aspect 5: The method of any of Aspects 1-4, wherein the second access filter includes one or more sub-filters including one or more of a first sub-filter or a second sub-filter.

Aspect 6: The method of any of Aspects 1-5, further comprising transmitting, to the one or more tags in the tag population, a read command in accordance with one or more of the first access filter or the second access filter.

Aspect 7: The method of any of Aspects 1-6, wherein transmitting the one or more select commands includes transmitting the one or more select commands in accordance with one or more parameters.

Aspect 8: The method of Aspect 7, wherein each of the one or more parameters is associated with an action field.

Aspect 9: The method of any of Aspects 1-8, further comprising determining an order of the one or more filters.

Aspect 10: The method of Aspect 9, wherein determining the order of the one or more filters includes scheduling the selection filter to be transmitted before one or more of the first access filter or the second access filter.

Aspect 11: The method of Aspect 9, wherein determining the order of the one or more filters includes scheduling two or more sub-filters of the first access filter to be transmitted before the second access filter or one or more sub-filters of the second access filter.

Aspect 12: The method of Aspect 9, wherein determining the order of the one or more filters includes scheduling two or more sub-filters of the first access filter or the second access filter to be transmitted sequentially.

Aspect 13: A system configured to perform one or more operations recited in one or more of Aspects 1-12.

Aspect 14: An apparatus comprising means for performing one or more operations recited in one or more of Aspects 1-12.

Aspect 15: A non-transitory computer-readable medium storing a set of instructions, the set of instructions comprising one or more instructions that, when executed by a device, cause the device to perform one or more operations recited in one or more of Aspects 1-12.

Aspect 16: A computer program product comprising instructions or code for executing one or more operations recited in one or more of Aspects 1-12.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, since those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A radio frequency identification (RFID) reader, comprising:
a processing system that includes one or more processors and one or more code-storing memories coupled with the one or more processors, the processing system configured to cause the RFID reader to:
select one or more filters to reduce a tag population to a tag sub-population; and
transmit, to one or more tags in the tag population and as part of a set operation, one or more select commands associated with the one or more filters,
wherein the one or more filters include one or more of a selection filter, a first access filter, or a second access filter,
wherein the set operation commands the one or more tags in the tag population to set or update a selected flag value or an inventoried flag value in accordance with one or more of the selection filter, the first access filter, or the second access filter.

2. The RFID reader of claim 1, wherein the processing system, to cause the RFID reader to command the one or more tags in the tag population to set or update the selected flag value or the inventoried flag value, is configured to cause the RFID reader to command the one or more tags in the tag population to assert, de-assert, or negate one or more of the selected flag value or the inventoried flag value.

3. The RFID reader of claim 1, wherein the first access filter includes one or more sub-filters including one or more of a first sub-filter or a second sub-filter.

4. The RFID reader of claim 3, wherein each of the one or more sub-filters is associated with consecutive bitmask values.

5. The RFID reader of claim 1, wherein the second access filter includes one or more sub-filters including one or more of a first sub-filter or a second sub-filter.

6. The RFID reader of claim 1, wherein the processing system is configured to cause the RFID reader to transmit, to the one or more tags in the tag population, a read command in accordance with one or more of the first access filter or the second access filter.

7. The RFID reader of claim 1, wherein the processing system, to cause the RFID reader to transmit the one or more select commands, is configured to cause the RFID reader to transmit the one or more select commands in accordance with one or more parameters.

8. The RFID reader of claim 7, wherein each of the one or more parameters is associated with an action field.

9. The RFID reader of claim 1, wherein the processing system is configured to cause the RFID reader to determine an order of the one or more filters.

10. The RFID reader of claim 9, wherein the processing system, to cause the RFID reader to determine the order of the one or more filters, is configured to cause the RFID reader to schedule the selection filter to be transmitted before one or more of the first access filter or the second access filter.

11. The RFID reader of claim 9, wherein the processing system, to cause the RFID reader to determine the order of the one or more filters, is configured to cause the RFID reader to schedule two or more sub-filters of the first access filter to be transmitted before the second access filter or one or more sub-filters of the second access filter.

12. The RFID reader of claim 9, wherein the processing system, to cause the RFID reader to determine the order of the one or more filters, is configured to cause the RFID reader to schedule two or more sub-filters of the first access filter or the second access filter to be transmitted sequentially.

13. A method of wireless communication performed by a radio frequency identification reader, comprising:
selecting one or more filters to reduce a tag population to a tag sub-population; and
transmitting, to one or more tags in the tag population and as part of a set operation, one or more select commands associated with the one or more filters,
wherein the one or more filters include one or more of a selection filter, a first access filter, or a second access filter,
wherein the set operation commands the one or more tags in the tag population to set or update a selected flag value or an inventoried flag value in accordance with one or more of the selection filter, the first access filter, or the second access filter.

14. The method of claim 13, wherein commanding the one or more tags in the tag population to set or update the selected flag value or the inventoried flag value includes commanding the one or more tags in the tag population to assert, de-assert, or negate one or more of the selected flag value or the inventoried flag value.

15. The method of claim 13, further comprising transmitting, to the one or more tags in the tag population, a read command in accordance with one or more of the first access filter or the second access filter.

16. The method of claim 13, wherein transmitting the one or more select commands includes transmitting the one or more select commands in accordance with one or more parameters.

17. The method of claim 13, further comprising determining an order of the one or more filters.

18. The method of claim 17, wherein determining the order of the one or more filters includes scheduling the selection filter to be transmitted before one or more of the first access filter or the second access filter.

19. The method of claim 17, wherein determining the order of the one or more filters includes scheduling two or more sub-filters of the first access filter to be transmitted before the second access filter or one or more sub-filters of the second access filter.

20. A non-transitory computer-readable medium storing a set of instructions for wireless communication, the set of instructions comprising:
one or more instructions that, when executed by one or more processors of an RFID reader, cause the RFID reader to:
select one or more filters to reduce a tag population to a tag sub-population; and transmit, to one or more tags in the tag population and as part of a set operation, one or more select commands associated with the one or more filters,
wherein the one or more filters include one or more of a selection filter, a first access filter, or a second access filter,
wherein the set operation commands the one or more tags in the tag population to set or update a selected flag value or an inventoried flag value in accordance with one or more of the selection filter, the first access filter, or the second access filter.
